(19) United States
(12) Patent Application Publication
(10) Pub. No.: US 2006/0164844 A1
(43) Pub. Date: Jul. 27, 2006

(54) Light fitting

(76) Inventor: Ban Chin To, Tungkuan (CN)

Correspondence Address: BRADLEY N. RUBEN, PC, 463 FIRST ST, SUITE 5A, HOBOKEN, NJ, 07030, US

(21) Appl. No.: 10/501,315

(22) PCT Filed: Jan. 22, 2003
(86) PCT No.: PCT/GB03/00290

§ 371 Date: Feb. 9, 2006

(30) Foreign Application Priority Data
Jan. 23, 2002 (GB) 0201479.3

(51) Int. Cl. F21V 19/00

(52) U.S. Cl. 362/382

(57) ABSTRACT

A light fitting (10) comprises a support surround (12), a front fascia (76) and a resilient fascia retainer (84), which may be spring clips, for holding the fascia in position and enabling removal of the fascia by a translational movement. The front fascia may be directly connected to the support surround or an intermediate member (86) may be provided to pivotally support the front fascia A lamp and lamp retainer are also provided such that the lamp may be moved relative to the retainer. The lamp retainer may form the front fascia or optionally comprises a tube. The front fascia may have a non-circular section such as a regular polygon. The support surround includes at least one spring arm for holding the light fitting in place on a layer of building.

The present invention relates to light fittings, such as downlighters. The invention also extends to light fittings including lamps comprising dichroic lamp bulbs, such as 12 v bulbs.

Known downlighters have a circular section and, in order to remove the lamp, for replacement purposes, a circlip is provided for holding the lamp in position. To remove the lamp; the circlip is first removed and the lamp may then be changed. Alternatively, a lamp may be held to a circular body of the fitting by a circular retainer which may be locked in position on a surrounding body of the downlighter with a twisting action. To remove the bulb, the circular retainer is twisted inside the circular body and may then be removed. These structures designed for enabling lamp replacement may not be suitable for all applications.

According to a first aspect of the present invention there is provided a light fitting having a support surround and a front facia, and a facia retainer for holding the front facia in position, the facia retainer being resilient for enabling removal of the facia from an installed position by a generally translational movement. This movement may be provided by application of force in an axial direction of the light fitting.

This is advantageous, since the front facia may be arranged to retain a lamp and the facia and/or lamp may easily be removed for replacement or servicing purposes with a simple force applied to the light fitting, without the requirement to remove a circlip, or the requirement to twist before removal. Since a twisting action is not required, the twisting action itself resulting in the requirement for circular facia and surround components in the prior art, it is possible to form the light fitting, support surround, front facia and/or any lamp with a non-circular section, such as when viewed in the direction of main light projection from a lamp of the light fitting.

Preferably, a lamp retainer and a lamp are provided, the lamp being resiliently retained by the lamp retainer such that the lamp may be moved relative to the retainer. This is advantageous in that it allows the lamp to be pushed, such as by a finger of a person changing the lamp, away from the retainer such that the finger may then be used to pull the retainer, such as for removing the lamp retainer and lamp from the light fitting.

According to a second aspect of the present invention there is provided a light fitting having a support surround, a lamp retainer, and a lamp, the lamp being resiliently retained by the lamp retainer such that the lamp may be moved relative to the retainer.

Preferably, a front facia and a facia retainer for holding the front facia in position are provided, the facia retainer being resilient for enabling removal of the facia from an installed position by a generally translational movement.

A number of optional features which may be applicable to either of the aforementioned aspects of the invention will now be discussed.

The lamp retainer may form the front facia. In this case, the lamp may be resiliently retained by the front facia such that the lamp may be moved relative to the front facia. Thus, the lamp may be moved relative to the lamp retainer in a rearward direction, for example, by tool or a finger of a person replacing or servicing the light fitting, and the tool or finger may then be used to pull the front facia and lamp away from the support surround for replacement or servicing of the lamp.

Alternatively, the lamp retainer may comprise a light tube extending axially in front of the lamp. The light tube may extend from the lamp to the front facia. Thus, the light tube may space the lamp rearwards relative to a front surface of the front facia for providing a desired projection of light from the light fitting. The light tube may thus form a light baffle.

The front facia may have a non-circular cross-section. The cross-section may be a regular polygon. The cross-section may be hexagonal or square.

The support surround may include at least one spring arm for holding the light fitting in place on a layer of building material.

The front facia may be directly retained by the facia retainer to the support surround. Alternatively, the front facia may be attached by the facia retainer to an intermediate member, the intermediate member being connected to the support surround. In this case, the intermediate member may be pivotally coupled to the support surround. The intermediate member may have a non-circular cross-section. This cross-section may be a regular polygon, such as a hexagon or square.

The facia retainer may comprise at least one spring clip. Preferably, a pair of said spring clips are provided, located on opposed sides of the light fitting. The spring clips are preferably secured to the front facia.

Preferably, a spring is provided for biasing the lamp towards the front facia. The spring is preferably arranged to provide force in response to axial extension thereof. The spring may be a helical spring such as of spring steel. Preferably, at least two said springs are provided, each extending from one end of the lamp opposite a lens end thereof to the lamp retainer. Where an intermediate member is provided, said springs may extend from an end of the lamp opposite the lens end thereof to the intermediate member. The intermediate member may be connected to the facia by one or more springs. Preferably, each spring which extends from an end of the lamp opposite the lens end thereof, extends from an electrical connector. The electrical connector may be mounted on one or more electrical connector pegs located on the lamp. Preferably, two opposed springs extend from the electrical connector to the lamp retainer in the form of the front facia or intermediate member, where provided, so as to retain the lamp in position.

Preferably, the facia includes a recessed ledge for engaging the perimeter of a lamp. Where a lamp is provided, this may have a front face which comprises a flat panel. The recessed ledge may enable a person wishing to change a lamp of the light fitting to push the lamp backwards away from the recessed ledge, such as with a finger, and then to pull on the recessed ledge to remove the front facia and lamp from the support surround.

Preferably, a lamp is provided, the lamp having a flat front surface.

The light fitting may comprise a downlighter.

According to a further aspect of the invention there is provided a building having a layer of building material and a light fitting as in either of the aforementioned aspects of the invention secured to a layer of building material. The support surround may be located around an aperture formed through the layer of building material. The support surround preferably has a flat front surface. The front facia may have a front surface flush with the front surface of the support surround. The lamp may be recessed behind the front facia.

The present invention may be carried out in various ways and a number of preferred light fittings in accordance with the invention will now be described by way of example with reference to the accompanying drawings in which:

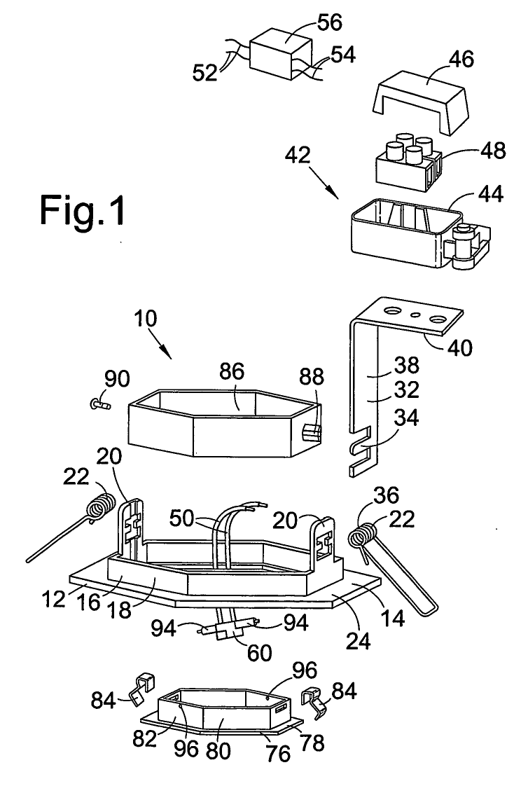

FIG. 1 is an exploded perspective view of parts of a preferred light fitting in accordance with the invention;

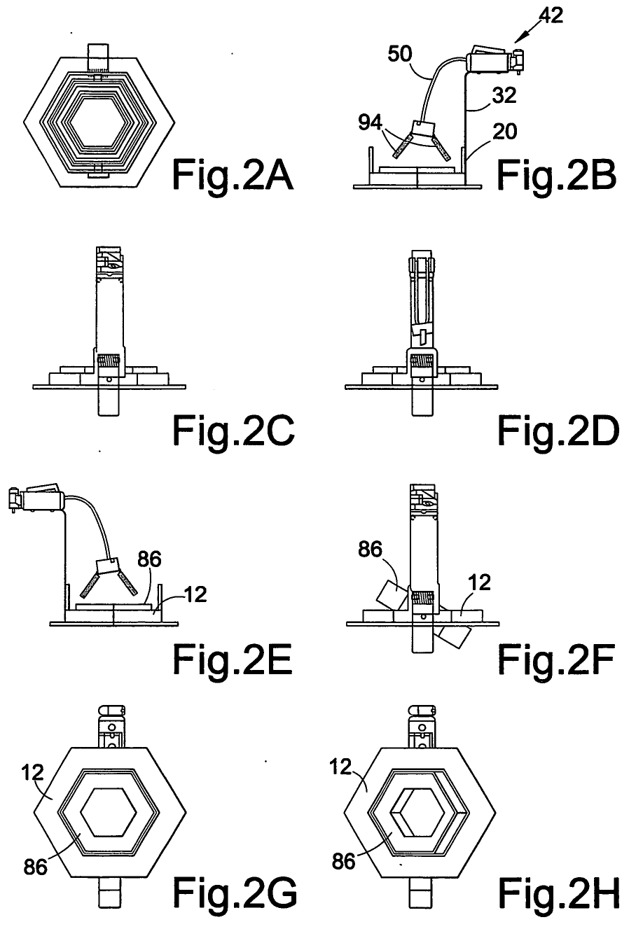

FIGS. 2A to 2H are various-elevations of the light fitting of FIG. 1;

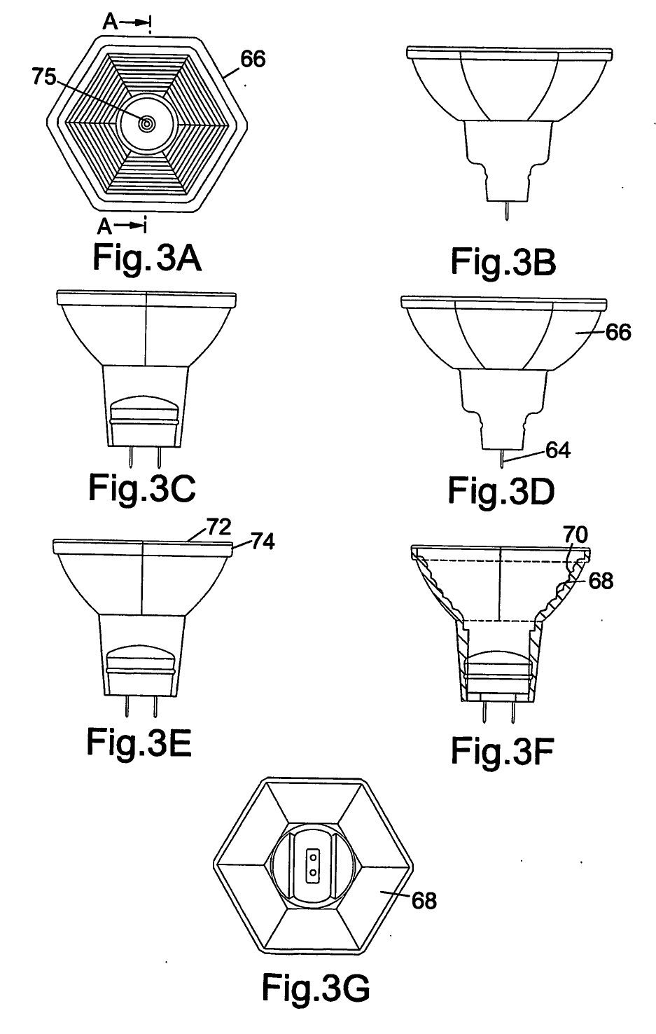

FIGS. 3A to 3G are various elevations of a lamp of the light fitting;

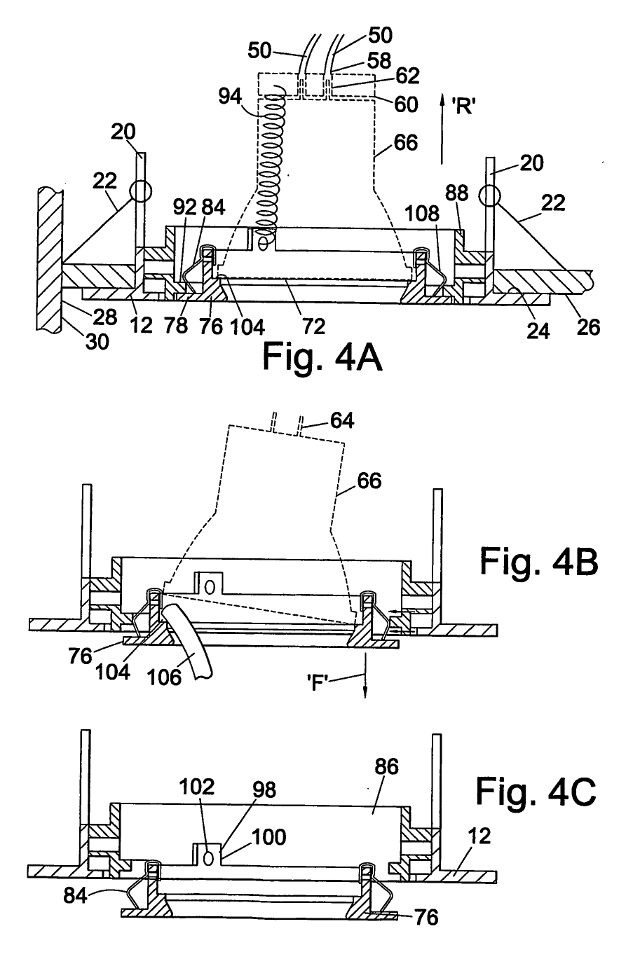

FIGS. 4A to 4C are three views demonstrating removal of a front facia and lamp from the light fitting;

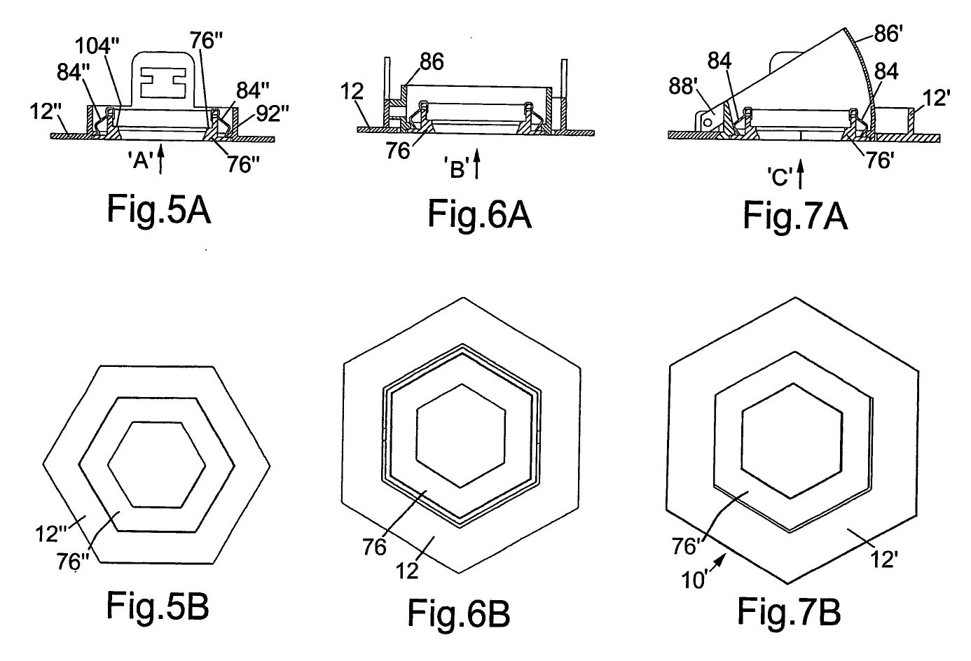

FIG. 5A is a cross-section of part of a modified light fitting and FIG. 5B is a view in the direction of arrow A in FIG. 5A;

FIG. 6A is a cross-section of part of the light fitting components of FIG. 1 and FIG. 6B is a view in the direction of arrow B in FIG. 6A;

FIG. 7A is a cross-section of part of the second modified light fitting in accordance with the invention and FIG. 7B is a view in the direction C in FIG. 7A;

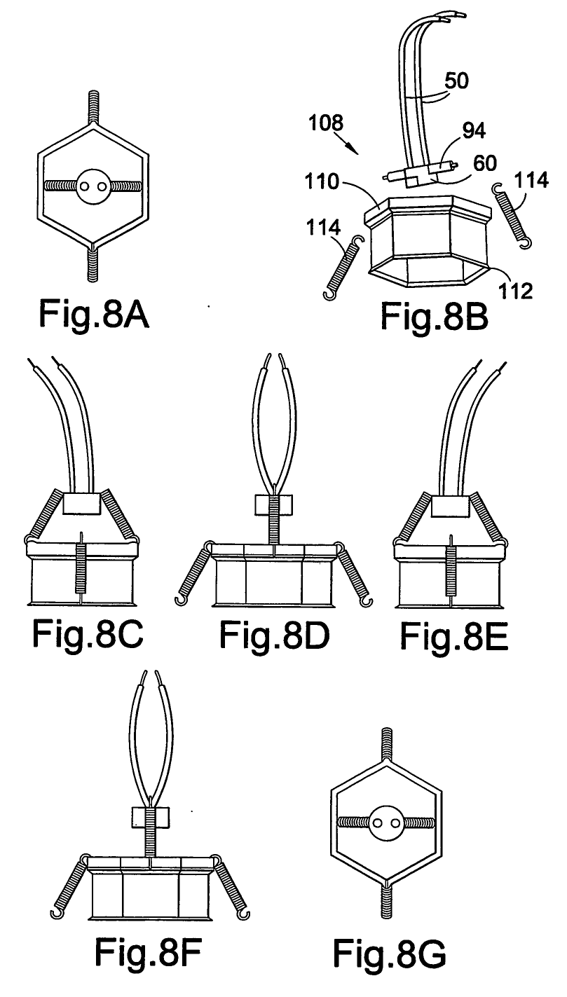

FIG. 8A to 8G are various views of an optional light tube for use with any of the light fittings of FIGS. 1 to 7B;

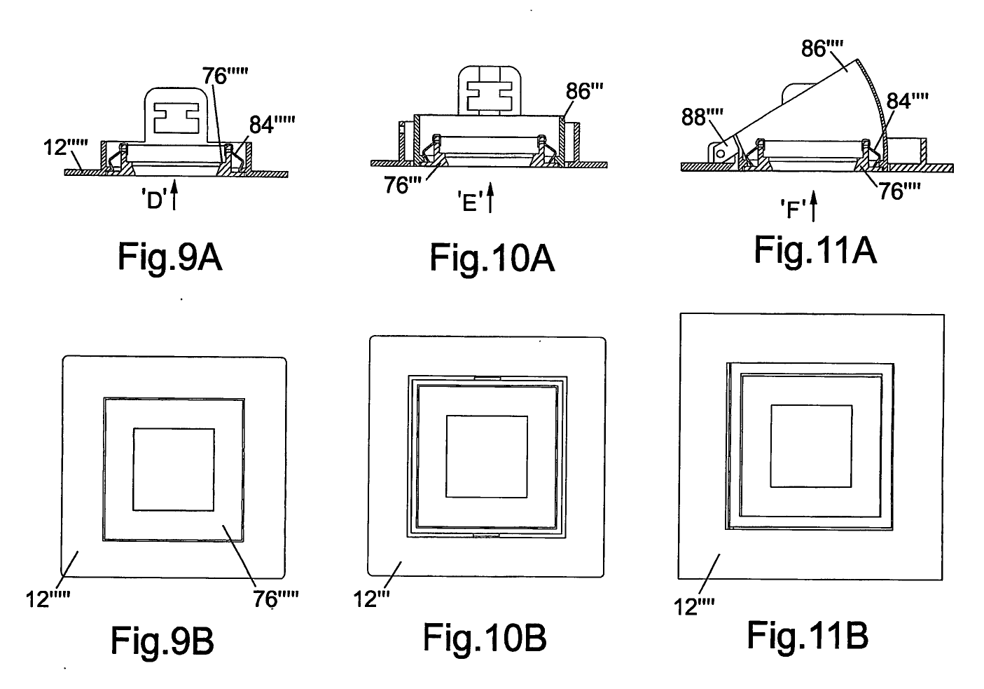

FIGS. 9A to 11B show alternative light fittings, having a square form, FIGS. 9B, 10B and 11B being views in the directions D, E and F respectively, in FIGS. 9A, 10A and 11A; and

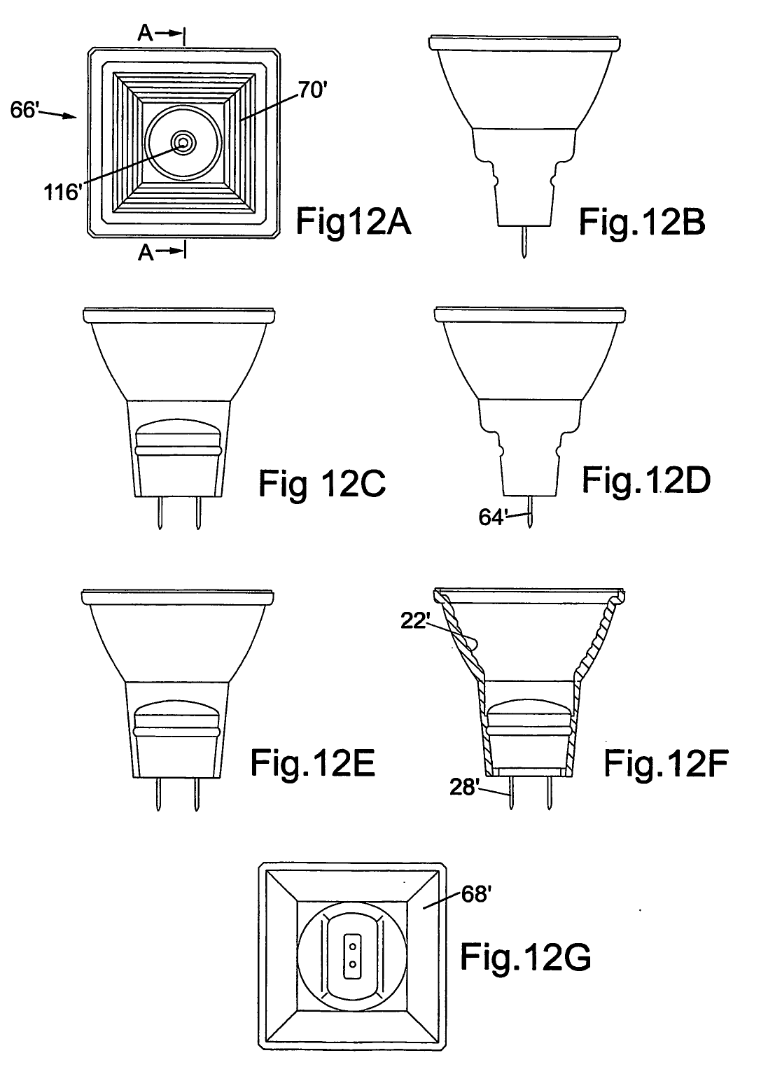

FIGS. 12A to 12G are various views of a lamp with a square form for use with the fittings of FIGS. 9A to 11B.

FIG. 1 shows a preferred embodiment of a light fitting 10 in the form of a downlighter in accordance with a preferred embodiment of the present invention. The downlighter 10 includes a hexagonal support surround 12 having a hexagonal ring-like front flange 14 and an inner hexagonal wall 16, each of six arms 18 of the wall extending rearwardly from and perpendicular to the flat front flange 14. The wall 16 includes two connection flanges 20, each holding a support spring 22 for holding the light fitting 10 in place with a rear surface 24 of the flange 14 abutting against and parallel to a layer of building material 26 in the form of part of a ceiling in a building 28 having a wall 30 (FIG. 4A). One of the connector flanges 20 also holds a bracket 32, a finger 34 of the bracket passing through and being retained by a coil portion 36 of the adjacent support spring 22. The bracket 32 is L-shaped and includes a rearwardly extending portion 38 and an end portion 40 attached and perpendicular thereto. Attached to the end portion is an electrical connector 42, comprising a housing 44 with a lid 46 and a wiring connection device 48. The wiring connection device 48 enables lamp wires 50 to be connected to mains wires 52, optionally via transformer wires 54 and transformer 56.

As shown in FIG. 4A, the lamp wires 50 each terminate at one end 58 thereof at an electrical connector 60 including terminals 62 for electrical connection to lamp pegs 64 of a lamp 66. As shown in FIGS. 3A to 3G, the lamp 66 has a hexagonal cross-section when viewed along a longitudinal axis thereof. In the case of a light fitting with a transformer 56, the lamp may be a 12 v dichroic lamp 66. The hexagonal lamp 66 includes six reflector faces 68 which are each slightly outwardly concave, each including a series of parallel outwardly convex reflector portions 70. The lamp 66 has a flat front face 72 (see FIG. 4A) having a perimeter 74. The lamp 66 has a central bulb 75. The lamp 66 is retained in place in the light fitting 10 by a hexagonal lamp retainer 76 in the form of a front facia of the light fitting. The front facia 76 includes a hexagonal front flange 78 and a rearwardly extending hexagonal wall 80 having six arm portions 82. Two of the arm portions have retainer devices 84 secured thereto, the retainer devices 84 each have a V-shaped portion 108. The retainer devices 84 are thus adapted to retain the front facia 76 on a hexagonal intermediate member 86 which may be hinged by hinge portions 88 using pivot pins 90, which may take the form of rivets 90, to the support surround 12. The intermediate member 86 includes an interior peripheral ledge 92 which the clips 84 are adapted to engage with a spring force, so as to maintain the front facia in a fixed position relative to the intermediate member 86. As shown by FIGS. 2E and 2F, as well as 2G and 2H, the intermediate member 86 may be tilted one way or the other, by virtue of the hinge portions 88, so that light emitted from the lamp 66 may be directed as desired.

Two helical springs 94 (only one of which is shown in FIG. 4A for the purposes of clarity) extend from the electrical connector 60 to spring connector holes 96 (FIG. 1) on opposite arms 82 of the wall 80 of the front facia 76, or alternatively to modified connection portions 98 (FIG. 4C) comprising rearwardly extending flanges 100 of the front facia 76 together with apertures 102.

As shown in FIG. 4A, the springs 94 are under tension when the lamp 66 is fitted, such that the lamp 66 is compressed between the connector 60 and a recessed peripheral ledge 104 of the front facia 76.

As shown in FIGS. 4A, 4B and 4C, to remove the lamp 66 for servicing or replacement, from the installed position shown in FIG. 4A, using a finger 106 or a suitable tool (not shown), a person may first push the lamp 66 in the rearward or upper direction shown by the arrow R in FIG. 4A, such that the lamp moves in this direction relative to the lamp retainer/front facia 76. The finger 106 or tool may then be engaged behind the ledge 104 in order to pull the front facia forwards or downwards in the direction of arrow F in FIG. 4B. It will be appreciated that the springs 94 advantageously enable the lamp 66 to be moved relative to the lamp retainer 76 so that purchase may easily be gained upon the retainer 76 for removal thereof together with the lamp. Additionally, the springs 84 enable the retainer/front facia 76 to be released with a simple forward movement and this enables the various components of the light fitting 10 to have a non-circular section, in this case a regular hexagon. Thus, extending flexible V-shaped portion 108 of each spring clip 84 is adapted for resilient compression inwardly towards the adjacent wall arm 82 of the front facia, as the front facia 76 moves from the position 4A to the position of 4B. FIG. 4C simply shows the support surround 12, intermediate member 86, and retainer/front facia 76 and clips 84 in a configuration once the front facia has been removed from retention by the intermediate member by virtue of the clips 84.

FIGS. 7A and 7B show a modified light fitting 10′ having similar components to those shown in the embodiment of FIG. 1, including a support surround 12′, front facia 76′, clips 84′, with a modified intermediate member 86′ which is bucket-shaped and hinged at a hinge portion 88′ to the support surround 12′ at one side of the light fitting. This enables greater rotation to one side than the embodiment of FIG. 1 and thus may be suitable for application to a ceiling for lighting of a wall such as in the region of a picture. FIG. 5A and FIG. 5B show a further modification, in which the intermediate member 86 is omitted, such that the front facia 76″ is directly retained by the support surround 12″, the recessed ledge 104″ of the front facia 76″ retaining the lamp 66 and the spring clips 84″ releasably retaining the front facia 76″ in position on the support surround 12″, with the clips 84″ resiliently engaging behind peripheral ledge 92″ of the support surround 12″.

FIGS. 8A to 8G show an optional light tube or baffle 108 which may take the place of the front facia 76 as the lamp retainer and may be positioned between the lamp 66 and the front facia 76. Thus, when the light tube 108 is used, the springs 94 may be connected to connection apertures 110 on the light tube 108 for clamping the lamp 66 between the connector 60 and the light tube 108, and the light tube 108, which consists of a hollow hexagonal and longitudinally extending tube 112 may be connected by connection springs 114 to the apertures 96,96′ for clamping the light tube to the front facia 76, thus holding the lamp 66 in position.

Instead of having a hexagonal form, the light fitting 10 may have other forms when viewed in the front or rearward direction thereof, such as other polygonal or regular polygonal shapes, such as a square shape. FIGS. 9A to 11B show three square embodiments equivalent to the three hexagonal embodiments shown in FIGS. 5A to 7B. Thus, in FIGS. 10A and 10B the square support surround 12′″ pivotally supports a square intermediate member 86′″ which holds a square front facia 76′″. In the embodiment of FIGS. 11A and 11B, a square front facia 76″″ pivotally supports a bucket-shaped intermediate member 86″″ at a side hinge 88″″, the intermediate member 86″″ supporting the front facia 76″″ by springs 84″″. Furthermore in FIGS. 9A and 9B, the front facia 76′″″ is retained directly by support 12′″″ using springs 84′″″. A square lamp 66′ for use with the embodiments of FIGS. 9A to 11B is shown in FIGS. 12A to 12G and includes four main reflector faces 68′ each including a series of parallel convex reflector portions 70′, a bulb 116 and electrical pegs 64′.

It will be appreciated that various modifications may be made to the embodiments described herewith without departing from the scope of the invention as defined by the accompanying claims as interpreted under patent law.

1-33. (canceled)

34. A light fitting having a support surround and a front facia, and a facia retainer for holding the facia in position, the facia retainer being resilient for enabling removal of the facia from an installed position thereof by a generally translational movement, the light fitting further having a lamp retainer and a lamp wherein the lamp is retained by the lamp retainer, the lamp being resiliently biassed toward the facia such that the lamp may be moved away from the facia against the resilient bias to provide access behind the facia to facilitate removal of the facia.

35. A light fitting as claimed in claim 34 in which the lamp retainer forms the front facia.

36. A light fitting as claimed in claim 34 in which the lamp retainer comprises a tube extending axially in front of the lamp.

37. A light fitting as claimed in claim 34 in which the front facia has a non-circular section.

38. A light fitting as claimed in claim 37 in which the cross-section is a regular polygon.

39. A light fitting as claimed in claim 37 in which the cross-section is hexagonal.

40. A light fitting as claimed in claim 37 in which the cross-section is square.

41. A light fitting as claimed in claim 34 in which the support surround includes at least one spring arm for holding the light fitting in place on a layer of building material.

42. A light fitting as claimed in claim 34 in which the front facia is directly retained by the facia retainer to the support surround.

43. A light fitting as claimed in claim 34 in which the front facia is attached by the facia retainer to an intermediate member, the intermediate member being connected to the support surround.

44. A light fitting as claimed in claim 43 in which the intermediate member is pivotally coupled to the support surround.

45. A light fitting as claimed in claim 43 in which the intermediate member has a non-circular section.

46. A light fitting as claimed in claim 45 in which the cross-section of the intermediate member is a regular polygon.

47. A light fitting as claimed in claim 46 in which the cross-section of the intermediate member is hexagonal.

48. A light fitting as claimed in claim 45 in which the cross-section of the intermediate member is square.

49. A light fitting as claimed in claim 34 in which the facia retainer comprises at least one spring clip.

50. A light fitting as claimed in claim 49 in which a pair of said spring clips is provided, located on opposed sides of the light fitting.

51. A light fitting as claimed in claim 49 in which each spring clip is secured to the front facia.

52. A light fitting as claimed in claim 34 in which the resilient biasing for biasing the lamp towards the front facia is provided by a spring.

53. A light fitting as claimed in claim 52 in which the spring is a helical spring.

54. A light fitting as claimed in claim 52 in which two said springs are provided, each extending from an end of the lamp opposite a lens end thereof to the lamp retainer.

55. A light fitting as claimed in claim 54 in which each spring extends from an electrical connector to the lamp retainer.

56. A light fitting as claimed in claim 34 in which the facia includes a recessed ledge for engaging the perimeter of a lamp.

57. A light fitting as claimed in claim 34 which includes a lamp, the lamp having a flat front surface.

58. A light fitting as claimed in claim 34 which comprises a downlighter.
